(19) United States
(12) Patent Application Publication
(10) Pub. No.: US 2004/0204209 A1
(43) Pub. Date: Oct. 14, 2004

(54) Headset storage system

(76) Inventor: John P. Bosch, Scottsdale, AZ (US)

Correspondence Address: STONEMAN LAW OFFICES, LTD, 3113 NORTH 3RD STREET, PHOENIX, AZ, 85012, US

(21) Appl. No.: 10/412,040

(22) Filed: Apr. 11, 2003

Related U.S. Application Data
(60) Provisional application No. 60/373,130, filed on Apr. 16, 2002.

(51) Int. Cl. H04B 1/38

(52) U.S. Cl. 455/575.2; 455/90.1

(57) ABSTRACT

A system for protectively storing a headset device of a wireless mobile phone. More particularly, a storage container independent from the headset device, comprising a rigid impact, dust and moisture-resistant housing of sufficient physical similarity to the headset device as to be readily identifiable as the correctly matching container. The system comprises a two-part housing joined by a hinge. Transparent portions of the housing permit the user to view the interior contents of the container. Additionally, the system may be provided as a consumer kit that includes the headset device, protective storage container and instructions for use.

### CROSS REFERENCE TO RELATED APPLICATION

The present application is related to and claims priority from applicant's prior U.S. Provisional Application Serial No. 60/373,130, filed Apr. 16, 2002, entitled “HEADSET STORAGE SYSTEM”, the contents of which are herein incorporated by reference and are not admitted to be prior art with respect to the present invention by their mention in this cross-reference section.

### BACKGROUND

This invention relates to providing an improved system for protectively storing the headset device of a wireless mobile phone. More particularly, it relates to a storage system independent from the headset device, comprising a rigid impact, dust and moisture-resistant housing of sufficient physical similarity to the headset device as to be readily identifiable as the correctly matching container.

Typically, wireless mobile phones are equipped with an adaptor to allow the use of a hands-free type headset device that includes an earpiece and a microphone. This feature is particularly useful when a user is driving a vehicle or engaged in other activities when it is inconvenient to hold the phone with one's hand. Such headsets typically attach to the mobile phone, however, when a user removes the headset, for example, when the user is in transit other than in the car, there is usually no specific storage place or safe place to secure the headset. Headsets are often damaged while placed in an unsafe or insecure location, for example, a vehicle tray. Such damage may be dramatically reduced by use of a safe and secure storage. In addition, users may have multiple phones in use by one or more persons, for example, traveling in the same vehicle, and it can be difficult to efficiently or rapidly find the matching headset.

### OBJECTS OF THE INVENTION

A primary object and feature of the present invention is to provide an improved system for holding and securely storing the headset of a wireless mobile phone. It is a further primary object and feature of the present invention to provide such a storage system independent from the headset and mobile phone. It is an additional primary object and feature of the present invention to provide such a system that provides a rigid protective housing for the headset. It is a further primary object and feature of the present invention to provide such a system that allows at least one view to the interior of such rigid protective housing. It is an additional primary object and feature of the present invention to provide such a system that is of sufficient physical similarity to the headset as to be readily identifiable as the correctly matching holder of the headset. A further primary object and feature of the present invention is to provide such a system that is efficient, inexpensive and handy. Other objects and features of this invention will become apparent with reference to the following descriptions.

### SUMMARY OF THE INVENTION

In accordance with a preferred embodiment hereof, this invention provides a headset storage system for removably storing at least one wireless headset device comprising: rigid holder means for snuggly, removeably holding the at least one wireless headset device; wherein such rigid holder means comprises: first housing means for defining an essentially hollow upper cavity; and second housing means for defining an essentially hollow lower cavity; wherein such rigid holder means comprises pivot means for pivotally interconnecting such first housing means and such second housing means such that such first housing means is movable with respect to such second housing means between an open position and a closed position; wherein such first housing means and such second housing means, in the closed position, define at least one hollow interior compartment; and wherein such rigid holder means is non-deformable. Moreover, it provides such a headset storage system wherein such rigid holder means further comprises viewing means for viewing such at least one hollow interior compartment from outside such rigid holder means even when such rigid holder means is in the closed position.

Additionally, it provides such a headset storage system wherein such rigid holder means comprises identifier means for assisting the user in identifying such holder means as the means for holding the corresponding at least one wireless headset device. Also, it provides such a headset storage system wherein such rigid holder means further comprises releasable retainer means for releasably retaining such first housing means and such second housing means in adjacent contact such that rotation of such first housing means and such second housing means about such pivot means is prevented, thus retaining such holder means in the closed position. In addition, it provides such a headset storage system wherein such rigid holder means comprises hard plastic.

In accordance with another preferred embodiment hereof, this invention provides a headset storage system for removably storing at least one wireless headset device comprising: at least one rigid holder adapted to snuggly, removeably hold the at least one wireless headset device; wherein such at least one rigid holder comprises: at least one first housing structured and arranged to define an essentially hollow upper cavity; and at least one second housing structured and arranged to define an essentially hollow lower cavity; wherein such at least one rigid holder comprises at least one hinge to pivotally interconnect such at least one first housing and such at least one second housing such that such at least one first housing is movable with respect to such at least one second housing between an open position and a closed position; wherein such at least one first housing and such at least one second housing, while in the closed position, define at least one hollow interior compartment; and wherein such rigid holder means is non-deformable. And, it provides such a headset storage system wherein such at least one rigid holder comprises at least one transparent portion adapted to provide a view of such at least one hollow interior compartment from outside such at least one rigid holder, even when such at least one rigid holder is in the closed position.

Further, it provides such a headset storage system wherein such at least one rigid holder comprises at least one associative identifier to assist the user in associating such at least one holder with the least one wireless headset device. Even further, it provides such a headset storage system wherein such at least one associative identifier is selected from the group consisting of shape, color, texture, transparency and indicia.

Moreover, it provides such a headset storage system further comprising at least one wireless headset device. Additionally, it provides such a headset storage system wherein such at least one second housing comprises at least one positioner adapted to securely position the at least one wireless headset device within such at least one hollow interior compartment. Also, it provides such a headset storage system wherein such at least one rigid holder further comprises at least one releasable retainer to releasably retain such at least one first housing in adjacent contact with such at least one second housing such that rotation of such at least one first housing and such at least one second housing means about such at least one hinge is prevented, thus retaining such at least one holder in the closed position.

In addition, it provides such a headset storage system wherein such at least one rigid holder comprises: at least one interiorly positioned flange projecting from such peripheral edge of such at least one first housing; and at least one exteriorly positioned flange projecting from such peripheral edge of such at least one second housing; wherein such at least one exteriorly positioned flange and such at least one interiorly positioned flange are structured and arranged to intermesh when such at least one rigid housing is in the closed position. And, it provides such a headset storage system wherein such non-deformable material comprises at least one rigid plastic. Further, it provides such a headset storage system wherein such non-deformable material comprises at least one metal. Even further, it provides such a headset storage system wherein such at least one rigid holder comprises at least one associative identifier to assist the user in associating such at least one holder with the least one wireless headset device. Even further, it provides such a headset storage system further comprising at least one wireless headset device.

In accordance with another preferred embodiment hereof, this invention provides a consumer kit for a headset storage system comprising: at least one wireless headset device; and at least one rigid headset storage system structured and arranged to snugly removeably hold such at least one wireless headset device. Even further, it provides such a consumer kit further comprising: at least one deformable packaging container to contain such at least one headset storage device in combination with such at least one headset device. Even further, it provides such a consumer kit further comprising at least one instruction set. Even further, it provides such a consumer kit wherein such at least one deformable packaging container comprises such at least one instruction set.

### BRIEF DESCRIPTION OF THE DRAWINGS

FIG. 1 is a front illustration of the headset storage system with a corresponding headset device according to a preferred embodiment of the present invention.

FIG. 2 is a perspective view illustrating the rigid holder of the headset storage system in an open position according to a preferred embodiment of the present invention.

FIG. 2a is a partial exploded view of the hinge assembly according to the embodiment of FIG. 1.

FIG. 3 is an interior view of the headset storage system with a corresponding headset device placed within the protective rigid holder according to a preferred embodiment of the present invention.

FIG. 4 is a front view of the headset storage system with a corresponding headset device partially visible through a transparent portion of the protective rigid holder according to a preferred embodiment of the present invention.

FIG. 4a is a side view of the headset storage system according to the embodiment of FIG. 4.

FIG. 4b is a sectional view through the section 4b-4b of FIG. 4a illustrating the interlocking peripheral edges of the headset storage system.

FIG. 5 is a rear view of the headset storage system with a corresponding headset device viewed through a transparent portion of the protective rigid holder according to the embodiment of FIG. 4.

FIG. 6 is a front view of the consumer kit for the headset storage system according to a preferred embodiment of the present invention.

FIG. 7 is a rear view of the consumer kit of the headset storage system according to a preferred embodiment of the present invention.

### DETAILED DESCRIPTION OF A PREFERRED EMBODIMENT OF THE INVENTION

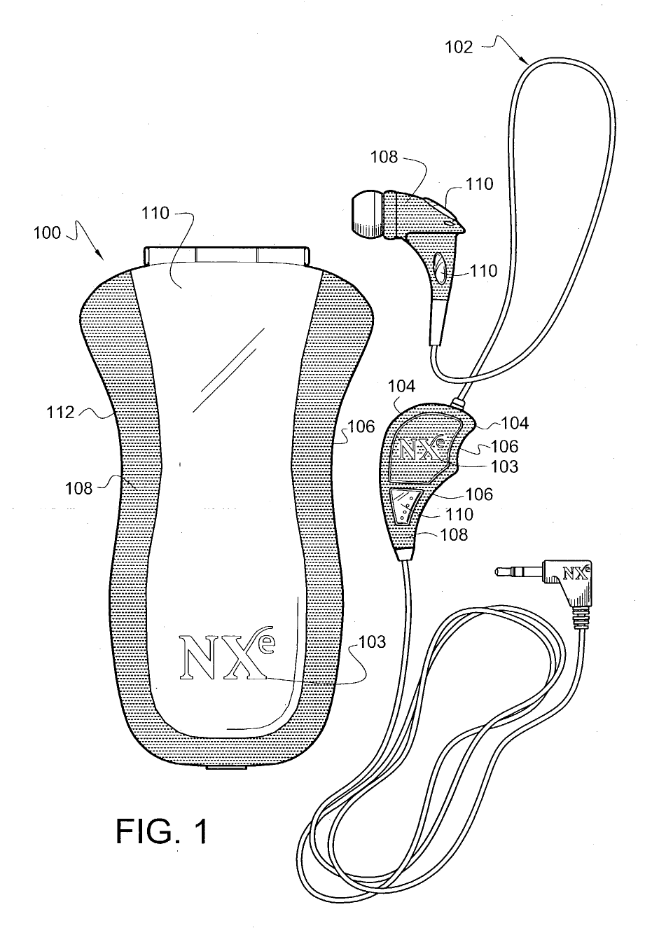

Referring now to the drawings, there is shown in FIGS. 1-7, preferred embodiments of a headset storage system, generally designated as headset storage system 100, according to the present invention.

FIG. 1 is a front view illustrating the headset storage system 100 with a corresponding headset device 102, according to a preferred embodiment of the present invention. Preferably, the headset storage system 100 comprises at least one protective rigid holder 112 (herein embodying rigid holder means), adapted to removably hold at least one headset device 102, as shown. Generally, wireless phone accessories, such as headset device 102, are constructed from relatively lightweight materials (to permit the devices to be comfortably worn by the user) and frequently contain sensitive internal electronic componentry. Consumer devices in this class are often inherently fragile, leaving them susceptible to damage during periods of storage. The rigid headset storage system 100 permits headset device 102 to be safely stored within a hard protective covering, when not in use, thereby extending the service life of the accessory device.

Preferably, the headset storage system 100 and the headset device 102 comprise one or more common physical similarities to provide an indication of related function. Preferably, a plurality of associative identifiers, such as shape, materials, color, finish, transparency, indicia, etc. (herein embodying identifier means and further herein embodying at least one associative identifier), is used to relate the headset storage system 100 to its corresponding headset device 102. The use of associative identifiers permits the user to quickly and efficiently match a wireless device accessory its corresponding storage container (herein embodying wherein such rigid holder means comprises identifier means for assisting the user in identifying such holder means as the means for holding the corresponding at least one wireless headset device and further herein embodying wherein such at least one rigid holder comprises at least one associative identifier to assist the user in associating such at least one holder with the least one wireless headset device). The ability of the user to make quick accessory/device storage associations is highly valuable in environments where multiple users are simultaneously storing accessories (such as in a family vehicle). In the embodiment of FIG. 1, ergonomically rounded forms, including convex-shaped portion(s) 104 and concave-shaped portion(s) 106 are used to visually associate the two elements, as shown. FIG. 1 also shows the preferred embodiment of the present invention utilizing a correspondence of material properties and finishes common to both the headset storage system 100 and its corresponding headset 102, as seen in the opaque portion(s) 108 having, for example, a metallic finish, and the transparent portion(s) 110 having, for example, matching colors or tinting. Those skilled in the art, upon reading the teachings of this specification, will appreciate that, under appropriate circumstances, considering such issues as cost and intended use, other arrangements associating the headset storage system 100 and its corresponding headset device 102, for example, the use of illumination or sound generation features, may suffice. Preferably, both the headset storage system 100 and its corresponding headset 102 contain corresponding indicia 103, indicating brand or device type, as shown. Preferably, the headset storage system 100 may be formed in a variety of easily gripped, ergonomic configurations having (in top view and side views) geometries that include square, rectangular, circular, hexagonal, triangular, ovoid, etc. Preferably, the headset storage system 100 is, in a closed position, essentially rectangular, comprising six adjoining surfaces, preferably with smoothly rounded adjoining edges and corners, as shown.

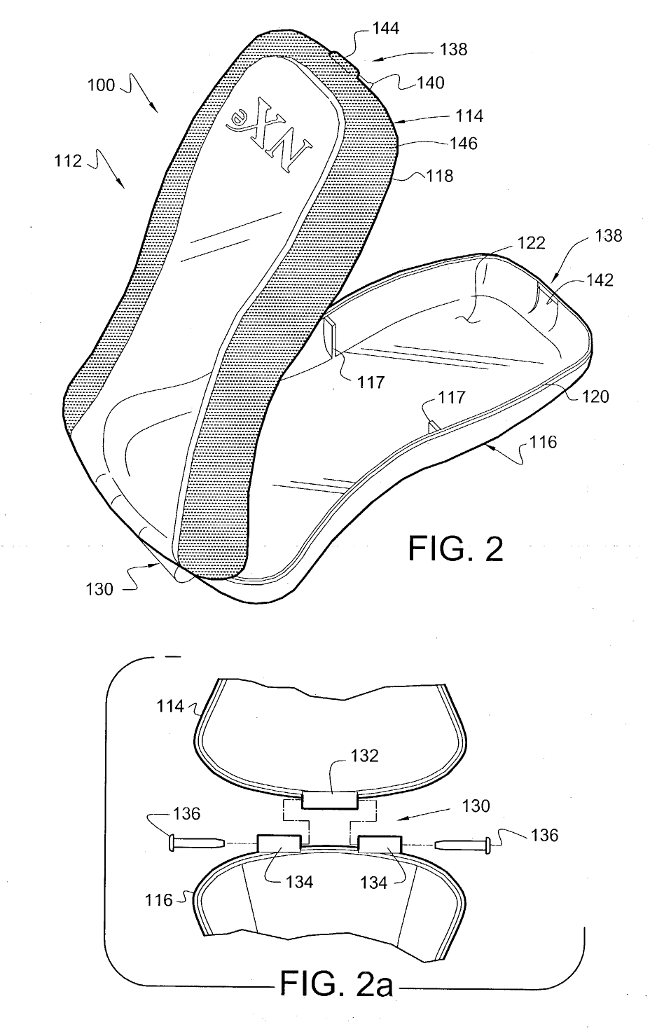

FIG. 2 is a perspective view illustrating the rigid holder of the headset storage system 100 in an open position, according to a preferred embodiment of the present invention. Preferably, the holder 112 is formed in two sections, at least one upper housing section 114 (herein embodying first housing means for defining an essentially hollow upper cavity and further herein embodying at least one first housing structured and arranged to define an essentially hollow upper cavity), and at least one lower housing section 116 (second housing means for defining an essentially hollow lower cavity and further herein embodying at least one second housing structured and arranged to define an essentially hollow lower cavity), as shown. The upper housing section 114 and lower housing section 116 are preferably constructed from a generally rigid and non-deforming material (herein embodying wherein such rigid holder means is non-deformable).

To address such issues as cost and ease of manufacturing, it is preferred that both sections of the holder 112 be constructed from the same material, preferably comprising transparent, rigid and moldable thermoplastic, preferably general-purpose polystyrene (such as “Styron 668” as manufactured by Dow Plastics, USA). Within the teachings of this specification, the term “transparent” may also comprise the term “translucent”, such that at least one portion of the housing material is sufficiently light-permeable to allow a user to determine if an object has been placed within the interior of the headset storage system 100. Any preferred color may be provided to the transparent portion(s) 110 by coating, mixing or blending the material forming the transparent portion(s) 110 with a pigment and/or dye, or by other well-known methods. Although it is preferred that a single plastic resin be used in the fabrication of the headset holder system 100 (to reduce production costs), those skilled in the art, upon reading the teachings of this specification, will appreciate that, under appropriate circumstances, two or more materials, copolymers, or mixtures may suffice.

Preferably, the upper housing section 114 and the lower housing section 116 are adapted such that, when the headset storage system 100 is in the closed position, the peripheral edge 118 of the upper housing section 114 and the peripheral edge 120 of the lower housing section 116 are interlocked. Additionally, in the closed position, a hollow interior compartment 122 (herein embodying wherein such first housing means and such second housing means, in the closed position, define at least one hollow interior compartment) is defined for holding the headset device 102, as shown.

The upper housing section 114 and lower housing section 116 are preferably joined by at least one hinge assembly 130 (herein embodying wherein such rigid holder means comprises pivot means for pivotally interconnecting such first housing means and such second housing means such that such first housing means is movable with respect to such second housing means between an open position and a closed position and further herein embodying wherein such at least one rigid holder comprises at least one hinge to pivotally interconnect such at least one first housing and such at least one second housing such that such at least one first housing is movable with respect to such at least one second housing between an open position and a closed position) that preferably allows the two housing sections to open and close in a clamshell-like manner, as shown.

Preferably located opposite the hinge assembly 130 is at least one clasp assembly 138 (herein embodying wherein such rigid holder means further comprises releasable retainer means for releasably retaining such first housing means and such second housing means in adjacent contact such that rotation of such first housing means and such second housing means about such pivot means is prevented, thus retaining such holder means in the closed position and further comprising at least one releasable retainer to releasably retain such at least one first housing in adjacent contact with such at least one-second housing such that rotation of such at least one first housing and such at least one second housing about such at least one hinge is prevented, thus retaining such at least one holder in the closed position), as shown. The clasp assembly 138 preferably comprises a clasp tab 140 integrally formed with the peripheral edge 118 of the upper housing section 114, and a clasp tab receiver socket 142 integrally formed with the interior peripheral edge 120 of the lower housing section 116, as shown. Preferably, the clasp tab 140 and clasp tab receiver socket 142 are adapted to releaseably interlock when the two sections of the holder 112 are in the closed (shut) position, thus forming a locked but releasable closure therebetween, thereby securing the contents of the holder 112. Additionally, a finger tab 144 is molded, as shown, to the exterior surface 146 of the upper housing section 114 near the clasp assembly 138 to aid the user in both releasing the clasp assembly 138, and in opening headset storage system 100. Those skilled in the art, upon reading the teachings of this specification, will appreciate that, under appropriate circumstances, considering such issues as cost and intended use, other suitable clasping/latching arrangements, such as hook and loop fasteners, straps, hooks and similar fasteners may suffice.

Those skilled in the art, will appreciate that, under appropriate circumstances, considering such issues as material strength and methods of manufacture, the use of internal stiffeners, such as stiffener 117 may be used to assist in maintaining the rigidity of holder 112.

FIG. 2a is a partial exploded view of the hinge assembly 130 according to the embodiment of FIG. 1. The hinge assembly 130 may, under appropriate circumstances, be of any suitable hinge type and may be located at any preferred position along the peripheral edge of the upper housing section 114 and lower housing section 116. Preferably, the hinge assembly 130 comprises at least one cylindrical upper knuckle 132 integrally formed with the upper housing section 114, and at least one, preferably two, cylindrical lower knuckles 134 integrally formed with the lower housing section 116, as shown. Preferably, the upper knuckle 132 is interdigitally positioned between the two lower knuckles 134, and two retaining pin(s) 136 (preferably comprising the same rigid plastic as the housing sections) are pressed through the lower knuckles 134 and upper knuckle 132, thereby pivotally joining the two housing sections, as shown. It will be understood by those skilled in the art, based on the teachings of this disclosure, that under appropriate circumstances, considering such issues as cost and intended use, the hinge assembly 130 may be formed separately from the upper housing section 114 and lower housing section 116 without departing from the scope of the invention.

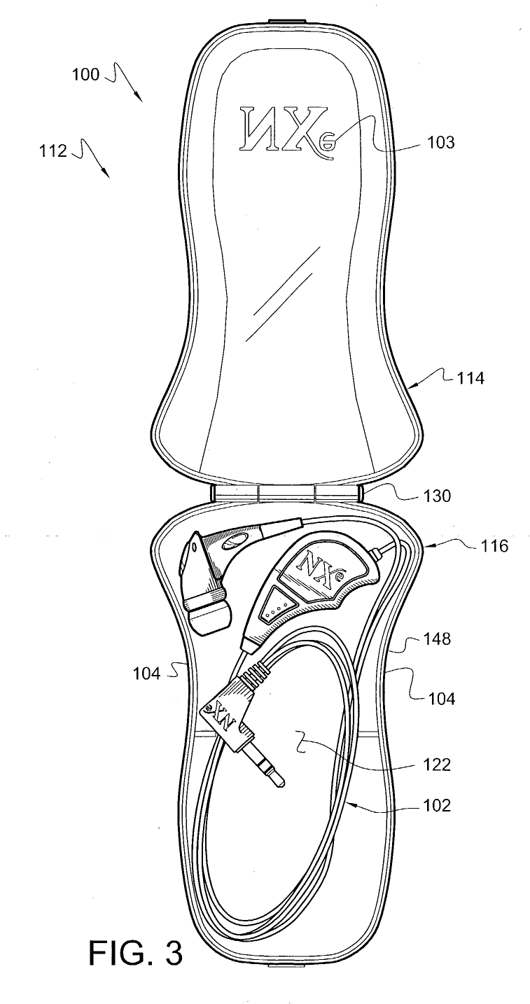

FIG. 3 is an interior view of the headset storage system 100 with a corresponding headset device 102 placed within the protective rigid holder 112, according to a preferred embodiment of the present invention. Preferably, the interior compartment 122 (herein embodying at least one hollow interior compartment) of the headset holder system 100 is purposely structured and arranged to snugly hold the headset device 102, as shown. Preferably, lower housing section 116 comprises at least one convex-shaped portion 104 (relative to the interior compartment 122) located essentially near the midpoint of the side 148, as shown. The convex-shaped portion 104 facilitates the secure retention of the headset cable within the interior compartment 122, as shown (herein embodying wherein such at least one second housing comprises at least one positioner adapted to securely position the at least one wireless headset device within such at least one hollow interior compartment). The smoothly transitioning geometry of the curving convex-shaped portion 104 preferably permits the headset device 102 to be easily placed and removed from the headset holder system 100 without hindrance. Those skilled in the art, upon reading the teachings of this specification, will appreciate that, under appropriate circumstances, considering such issues as intended use and specific accessory configuration, other methods of removably retaining the headset device 102 within the interior compartment 122 of the headset holder system 100, such as clips, clamps and hook-and-loop fasteners, may suffice.

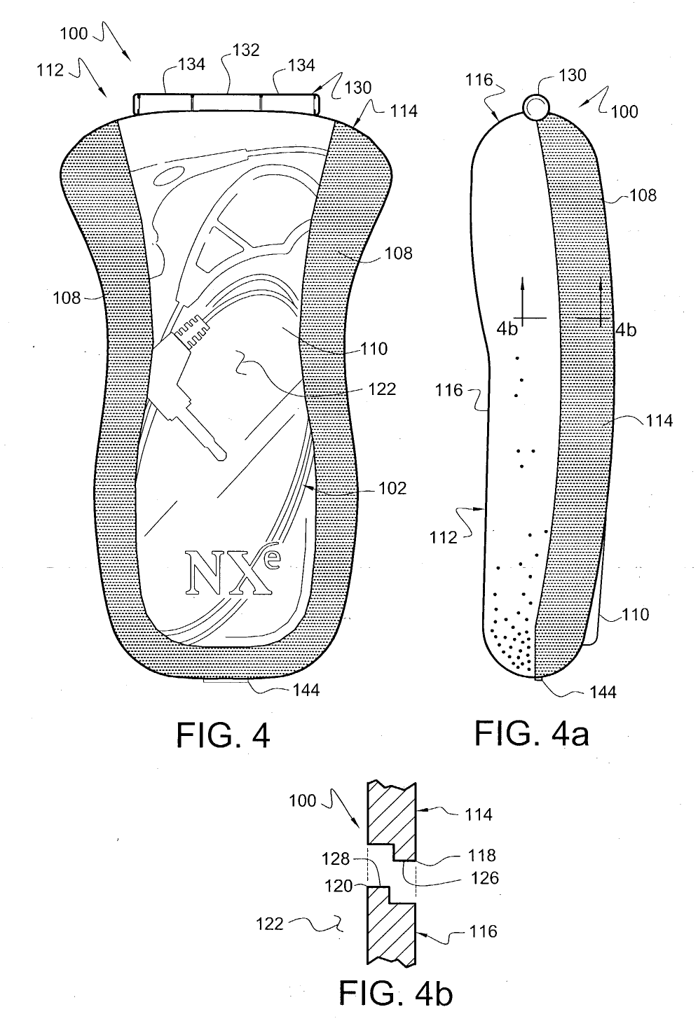

FIG. 4 is a front view of the headset storage system 100 with a corresponding headset device 102 partially visible through a transparent portion 110 of the upper housing section 114, according to a preferred embodiment of the present invention. Preferably, at least one transparent portion 110 is provided to indicate the contents of the interior compartment 122, even when the headset storage system 100 is in a closed position (herein embodying wherein such rigid holder means further comprises viewing means for viewing such at least one hollow interior compartment from outside such rigid holder means even when such rigid holder means is in the closed position and further herein embodying wherein such at least one rigid holder comprises at least one transparent portion adapted to provide a view of such at least one hollow interior compartment from outside such at least one rigid holder, even when such at least one rigid holder is in the closed position).

Associative identifiers, such as the opacity and finish of the opaque portions 108, may be applied to the materials of the headset storage system 100 in any suitable manner, including the use of an appliqué, opaque materials, or incorporating a compatible pigment or dye in the plastic material forming the holder. It is presently preferred to paint the opaque portions 108 to match the finish of the corresponding headset device 102, as shown.

FIG. 4a is a side view of the headset storage system 100 according to the embodiment of FIG. 4. In a closed position, the headset storage system 100 forms protective holder 112 that is essentially is impact, dust and moisture-resistant.

FIG. 4b is a sectional view through the section 4b-4b of FIG. 4a illustrating the interlocking peripheral edges of the headset storage system 100. Preferably, the peripheral edge 118 of the upper housing section 114 and the peripheral edge 120 of the lower housing section 116 each comprise at least one continuous complementary interlocking projection. Preferably, the peripheral edge 118 of the upper housing section 114 includes an exterior projecting flange 126 (herein embodying at least one exteriorly positioned flange). Similarly, the peripheral edge 120 of the lower housing section 116 includes a complementary interior projecting flange 128 (herein embodying at least one interiorly positioned flange), as shown. Preferably, both the exterior projecting flange 126 and interior projecting flange 128 are integrally formed with their respective housing sections, as shown. Preferably, the exterior projecting flange 126 and interior projecting flange 128 are configured such that when headset holder system 100 is in the closed position, the exterior projecting flange 126 and interior projecting flange 128 snuggly overlap, essentially sealing the interior compartment 122, as shown (herein embodying wherein such at least one exteriorly positioned flange and such at least one interiorly positioned flange are structured and arranged to intermesh when such at least one rigid housing is in the closed position).

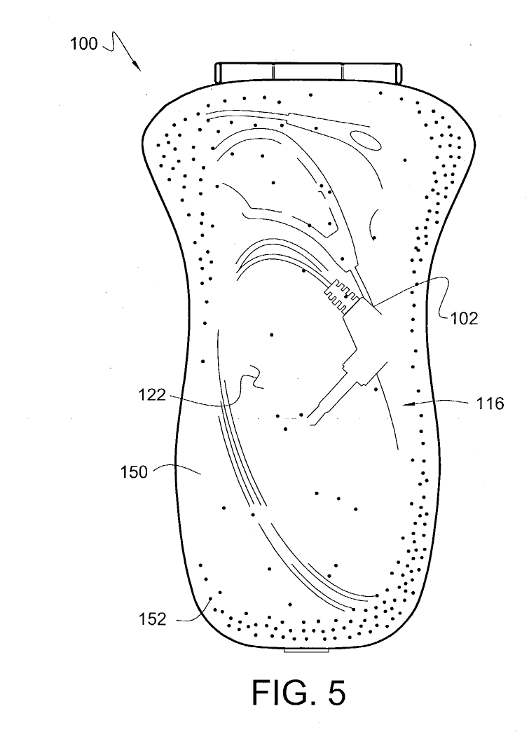

FIG. 5 is a rear view of the headset storage system 100 holding a corresponding headset device 102, an indication of which is visible through the transparent lower housing section 116, according to a preferred embodiment of the present invention. Although the use of opaque materials for the lower housing section 116 is within the scope of the present invention, it is presently preferred to utilize a translucent plastic, as shown. Preferably, an indication of the contents of the headset holder system 100 is provided to the user from several viewing angles, as shown. In the embodiment of FIG. 5, the exterior surface 150 of the lower housing portion 116 is textured, as shown. The preferred texturing 152 of portions of the exterior surface of the lower housing portion 116 (or upper housing portion 114) comprises one or more mold-formed surface finishes that facilitate secure gripping of the headset holder system 100. Preferably, texturing 152 is applied to the housing material such that views to the interior compartment 122 are not obscured, as shown. The headset storage system 100 may also be molded to include such preferable features as indicia or product marking (not shown).

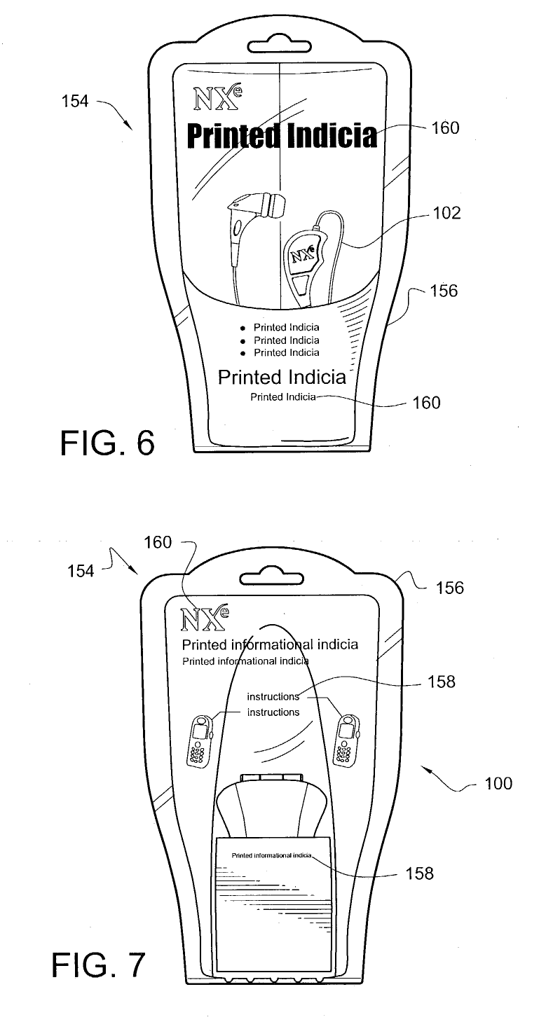

FIG. 6 is a front view of the consumer kit 154 for the headset storage system 100, according to a preferred embodiment of the present invention. Preferably, at least one headset device 102 is packaged in combination with at least one headset storage system 100 (as shown in FIG. 7). The deformable and disposable packaging 156 (herein embodying at least one deformable packaging container) of the consumer kit 154 may comprise cardboard or plastic. It is preferred that the disposable packaging comprises clear plastic. Preferably, the disposable packaging 156 is adapted to fit within standard retail merchandising hanger systems. Disposable packaging 156 may preferably comprise printed indicia 160 to indicate brand and product features, as shown.

FIG. 7 is a rear view of the consumer kit 154 of the headset storage system 100, according to a preferred embodiment of the present invention. The disposable packaging 156 is arranged to hold at least one headset storage system 100, as shown. It is preferred that product information and instructions 158 (herein embodying at least one instruction set) be included with the kit, preferably printed on the packaging, as shown (herein embodying wherein such at least one deformable packaging container comprises such at least one instruction set).

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A headset storage system for removably storing at least one wireless headset device comprising:
a) rigid holder means for snuggly, removeably holding the at least one wireless headset device;
b) wherein said rigid holder means comprises:
i) first housing means for defining an essentially hollow upper cavity; and
ii) second housing means for defining an essentially hollow lower cavity;
c) wherein said rigid holder means comprises pivot means for pivotally interconnecting said first housing means and said second housing means such that said first housing means is movable with respect to said second housing means between an open position and a closed position;
d) wherein said first housing means and said second housing means, in the closed position, define at least one hollow interior compartment; and
e) wherein said rigid holder means is non-deformable.

2) The headset storage system according to claim 1 wherein said rigid holder means further comprises viewing means for viewing said at least one hollow interior compartment from outside said rigid holder means even when said rigid holder means is in the closed position.

3) The headset storage system according to claim 1 wherein said rigid holder means comprises identifier means for assisting the user in identifying said holder means as the means for holding the corresponding at least one wireless headset device.

4) The headset storage system according to claim 1 wherein said rigid holder means further comprises releasable retainer means for releasably retaining said first housing means and said second housing means in adjacent contact such that rotation of said first housing means and said second housing means about said pivot means is prevented, thus retaining said holder means in the closed position.

5) The headset storage system according to claim 2 wherein said rigid holder means comprises hard plastic.

6) A headset storage system for removably storing at least one wireless headset device comprising:
a) at least one rigid holder adapted to snuggly, removeably hold the at least one wireless headset device;
b) wherein said at least one rigid holder comprises:
i) at least one first housing structured and arranged to define an essentially hollow upper cavity; and
ii) at least one second housing structured and arranged to define an essentially hollow lower cavity;
c) wherein said at least one rigid holder comprises at least one hinge to pivotally interconnect said at least one first housing and said at least one second housing such that said at least one first housing is movable with respect to said at least one second housing between an open position and a closed position;
d) wherein said at least one first housing and said at least one second housing, while in the closed position, define at least one hollow interior compartment; and
e) wherein said rigid holder means is non-deformable.

7) The headset storage system according to claim 6 wherein said at least one rigid holder comprises at least one transparent portion adapted to provide a view of said at least one hollow interior compartment from outside said at least one rigid holder, even when said at least one rigid holder is in the closed position.

8) The headset storage system according to claim 6 wherein said at least one rigid holder comprises at least one associative identifier to assist the user in associating said at least one holder with the least one wireless headset device.

9) The headset storage system according to claim 8 wherein said at least one associative identifier is selected from the group consisting of:
a) shape
b) materials
c) color
d) texture
e) transparency
f) indicia.

10) The headset storage system according to claim 6 further comprising at least one wireless headset device.

11) The headset storage system according to claim 6 wherein said at least one second housing comprises at least one positioner adapted to securely position the at least one wireless headset device within said at least one hollow interior compartment.

12) The headset storage system according to claim 7 wherein said at least one rigid holder further comprises at least one releasable retainer to releasably retain said at least one first housing in adjacent contact with said at least one second housing such that rotation of said at least one first housing and said at least one second housing about said at least one hinge is prevented, wherein said at least one holder may be retained in the closed position.

13) The headset storage system according to claim 12 wherein said at least one rigid holder comprises:
a) at least one interiorly positioned flange projecting from said peripheral edge of said at least one first housing; and
b) at least one exteriorly positioned flange projecting from said peripheral edge of said at least one second housing;
c) wherein said at least one exteriorly positioned flange and said at least one interiorly positioned flange are structured and arranged to intermesh when said at least one rigid housing is in the closed position.

14) The headset storage system according to claim 13 wherein said non-deformable material comprises at least one rigid plastic.

15) The headset storage system according to claim 13 wherein said non-deformable material comprises at least one metal.

16) The headset storage system according to claim 14 wherein said at least one rigid holder comprises at least one associative identifier to assist the user in associating said at least one holder with the least one wireless headset device.

17) The headset storage system according to claim 16 further comprising at least one wireless headset device.

18) A consumer kit for a headset storage system comprising:
a) at least one wireless headset device; and
b) at least one rigid headset storage system structured and arranged to snugly removeably hold said at least one wireless headset device.

19) The consumer kit according to claim 18 further comprising:
a) at least one deformable packaging container to contain said at least one headset storage device in combination with said at least one headset device.

20) The consumer kit according to claim 19 further comprising at least one instruction set.

21) The consumer kit according to claim 20 wherein said at least one deformable packaging container comprises said at least one instruction set.
